(19) United States
(12) Patent Application Publication
(10) Pub. No.: US 2026/0336334 A1
(43) Pub. Date: Oct. 29, 2026

(54) VEHICLE TYRE, METHOD FOR PRODUCING A VEHICLE TYRE AND VULCANIZING MOULD

(71) Applicant: Continental Reifen Deutschland GmbH, Hannover (DE)

(72) Inventors: Stefan Rittweger, Garbsen (DE); Juraj Jurco, Hannover (DE)

(73) Assignee: Continental Reifen Deutschland GmbH, Hannover (DE)

(21) Appl. No.: 19/121,448

(22) PCT Filed: Sep. 18, 2023
(86) PCT No.: PCT/DE2023/200185

§ 371 Date: Apr. 16, 2025

(30) Foreign Application Priority Data
Oct. 18, 2022 (DE) 10 2022 210 967.8

(51) Int. Cl. B60C 13/00; B29D 30/06; B29D 30/72

(52) U.S. Cl. CPC B60C 13/001; B29D 30/0606; B29D 30/72; B29D 2030/0616; B29D 2030/726

(57) ABSTRACT

A vehicle tire having at least one areal, structured element which is formed on the outer surface of said vehicle tire and contains a combination of macrostructures and microstructures, which are in each case structures which are elevated in relation to a base level, wherein the macrostructure consists of a multiplicity of ribs with apex regions which have a height) of 0.20 mm to 0.80 mm in relation to the base level wherein the microstructure covers surface elements provided between the ribs and is or comprises a non-uniform peak-and-trough contrast structure whose peaks have different heights, with a maximum height in relation to the base level that is smaller than the height of the ribs. The peaks of the peak-and-trough contrast structure have a height of 0.04 mm to 0.10 mm.

The invention relates to a vehicle tire having at least one areal, structured element which is formed on the outer surface of said vehicle tire and contains a combination of macrostructures and microstructures, which are in each case structures which are elevated in relation to a base level, wherein the macrostructure consists of a multiplicity of ribs with apex regions which have a height of 0.20 mm to 0.80 mm in relation to the base level, wherein the microstructure covers surface elements provided between the ribs and is or comprises a non-uniform peak-and-trough contrast structure whose peaks have different heights, with a maximum height in relation to the base level that is smaller than the height of the ribs.

The invention furthermore relates to a method for producing such a vehicle tire, and to a vulcanization mold for vulcanization of such a vehicle tire.

A vehicle tire of the type mentioned in the introduction is known from EP 2 691 246B1 . The tire has on its outer surface at least one areal, structured element with ribs which extend alongside one another and which have a substantially triangular cross section with inclined rib flanks which extend on both sides of the apex of the ribs toward the foot thereof, wherein the angle of inclination of the inclined rib flanks in relation to the base level is at most 25°. The surfaces provided between the ribs are referred to as remaining surfaces and are covered by a microstructure with an average roughness of 5 μm to 30 μm. The width of the remaining surfaces is smaller than or at most equal to half the height of the ribs, wherein said height is 0.10 mm to 0.80 mm. Since the ribs have a height which is greater than the width of the remaining surfaces, it is intended that the ribs be able to deflect incident light beams particularly well before they reach the remaining surfaces, in order in this manner to limit the amount of light that is received by the remaining surfaces. The low roughness of the microstructure in the range of 5 μm to 30 μm allows the remaining surfaces to act as virtually smooth surfaces that reflect incident light well and thus have barely any influence on the contrast effect of the structured element.

Structured elements formed on the outer surface of vehicle tires are normally in the form of characters, logos, images and the like and, in order to be particularly easy to see, are intended to be formed so as to contrast with the surrounding outer surfaces. In particular, these elements are intended to be structured in such a way that they reflect little light, that is to say “capture” impinging light, in order to allow said elements to appear to be darker than the surrounding surface regions to an observer from the outside.

Areal elements formed on the outer surface of vehicle tires that are composed of microstructures with an improved contrast effect are known for example from DE 10 2019 207 908A1 . These microstructures are in the form of roughness-imparting, surface-covering, non-uniform peak-and-trough contrast structures and have a surface-related roughness value Sa according to EN ISO 25178 of 50 μm to 150 μm. The contrast structures having peaks and troughs connected or transitioning into one another, and situated at different levels, that are formed in this manner can have their negative form produced in the vulcanization mold by means of a laser, are able to be ventilated well as the green tire is introduced for molding, and are able to be formed on the tire in a flawless state. In the case of the vehicle tire known from DE 10 2020 215 188A1 , the contrast structure consists of a multiplicity of contrast-structure cells which are joined together in the form of a raster and which are of corresponding shape in plan view and which in each case have surface-covering, non-uniform peak-and-trough structures. The arrangement of the contrast-structure cells is such that the non-uniform peak-and-trough contrast structures, when seen in plan view, are transferable one into the other by way of a congruence mapping.

The invention is based on the object of designing, in the case of a vehicle tire of the type mentioned in the introduction with at least one structured element which has a combination of macrostructures and microstructures, the surface elements provided between ribs of the macrostructure with a microstructure composed of a non-uniform peak-and-trough structure in such a way that the contrast effect of the structured elements is improved significantly by particularly effective scattering and absorption of incident light.

The stated object is achieved according to the invention in that the peaks of the peak-and-trough contrast structure have a height of 0.04 mm to 0.10 mm.

The height, based on the base level, of the peaks of the peak-and-trough contrast structure of the microstructure is therefore at least 40 μm and up to 100 μm, wherein the heights of the peaks vary in this range. Thus, due to the scattering of light and reflection of light that are consequently possible, the surface elements between the ribs contribute particularly effectively to the contrast of the areal, structured elements in relation to the surrounding outer surface, wherein it is possible to vary the distances between the ribs of the macrostructure in one and the same structured element and the macrostructure is configurable with ribs in various arrangements.

In a preferred embodiment, the peak-and-trough contrast structure extends so as to be interrupted by the ribs but otherwise continuously over the surface or at least a part of the surface of the structured element. Thus, peak-and-trough structures formed on one surface element can continue on the adjacent surface element, whereby a special contrast effect of the microstructure is achievable. Furthermore, the requisite negative structures of such microstructures and also those of the macrostructures are particularly easy to produce in a vulcanization mold.

In a further preferred embodiment, the peak-and-trough contrast structure is made up of a multiplicity of small-area contrast-structure cells which are joined together in the form of a raster and which are of corresponding shape in plan view, wherein, within each contrast-structure cell, the same non-uniformly designed peak-and-trough contrast structure is formed. In this case, the contrast-structure cells are arranged in particular in such a way as to be transferable one into the other by way of a congruence mapping. For example, the contrast-structure cells have the form of rectangles, in particular squares, in plan view and have edge lengths of 0.80 mm to 1.50 mm. As a result of the replication of contrast-structure cells, the peak-and-trough contrast structure is scaleable in terms of its size and a negative structure thereof in the corresponding mold surface of a tire vulcanization mold is simple to produce. In this case, the surface elements between the ribs may be largely made up of complete contrast-structure cells and in this way provide for a more uniform contrast effect of the surface elements provided with this microstructure.

Preferably, there is furthermore an embodiment in which the ribs of the macrostructure have a height of up to 0.60 mm, preferably of 0.25 mm to 0.35 mm. A particularly good contrast effect is achievable by this measure in conjunction with the height of the peaks of the microstructure, which is several times smaller.

In this case, the ribs, extending within a structured element, of the macrostructure may have heights that are equal and that remain constant over the extent of the ribs. In an alternative embodiment, either the ribs have a height that varies over its extent or provision is made of ribs that have different heights or different height profiles. In this way, the contrast effect of the structured elements can be influenced, in particular intensified, in a particularly advantageous manner, in particular also according to the position thereof on the tire outer surface.

The profile and the respective arrangement of the ribs also influences the achievable and desired contrast effect, wherein there are many possible configurations in this context.

In a particularly simple embodiment, the ribs extend alongside one another, in particular parallel or largely parallel to one another, in the manner of hatching, wherein the surface elements covered by a microstructure have a width of 0.20 mm to 0.80 mm between mutually adjacent ribs.

In a further advantageous embodiment, the ribs have successive rib portions which differ from one another in terms of their profile relative to the extent direction of the ribs, for example extend with a zigzag shape in plan view, or which, in plan view, have a specific configuration, for example in the form of correspondingly oriented isosceles trapezoids without a long base that are approximately equal in size.

For the purpose of further influencing and improving the contrast effect, the ribs may additionally have further rib portions which branch off from their rib portions. Advantageously here, the clear distance between rib portions of mutually adjacently extending ribs is at least 0.20 mm and in particular up to 0.80 mm. A certain minimum distance is advantageous for effective use of the contrast effect of the microstructure.

The invention furthermore relates to a method for producing a vehicle tire designed as claimed in one or more of claims 1 to 11, comprising the following steps: creating a negative contour of at least one structured element in a mold surface of a vulcanization mold for shape-imparting vulcanization of the vehicle tire,
wherein firstly the negative of the microstructure is created, by way of laser engraving of the mold surface, so as to extend over the entire area of the structured element to be formed,
and subsequently the negative structure of the macrostructure is created as depressions on the negative of the microstructure by way of laser engraving or by way of milling,
wherein, by means of the vulcanization mold, shape-imparting vulcanization of the tire blank of the vehicle tire is performed, whereby the structured element is stamped with a macrostructure composed of ribs and with the microstructure between the ribs, on the outer surface of the vehicle tire.

This method makes it possible for the negative contours of the structured elements provided on the tire to be created particularly faithfully and easily on the mold surface of the vulcanization mold and for the structured elements to subsequently be stamped faithfully during the vulcanization of the tire blank of the tire.

The vulcanization mold configured according to the invention for shape-imparting vulcanization of a vehicle tire designed as claimed in one or more of claims 1 to 11 has at least one mold surface in which the negative structure of a structured element made up of the macrostructure composed of ribs and the microstructure composed of a non-uniform peak-and-trough contrast structure is contained, wherein the negative structure has depressions for forming the ribs and the negative structure of the microstructure on surface elements between the ribs.

Further features, advantages and details of the invention will now be described in more detail on the basis of the schematic drawing, which illustrates a number of exemplary embodiments. In the drawing:

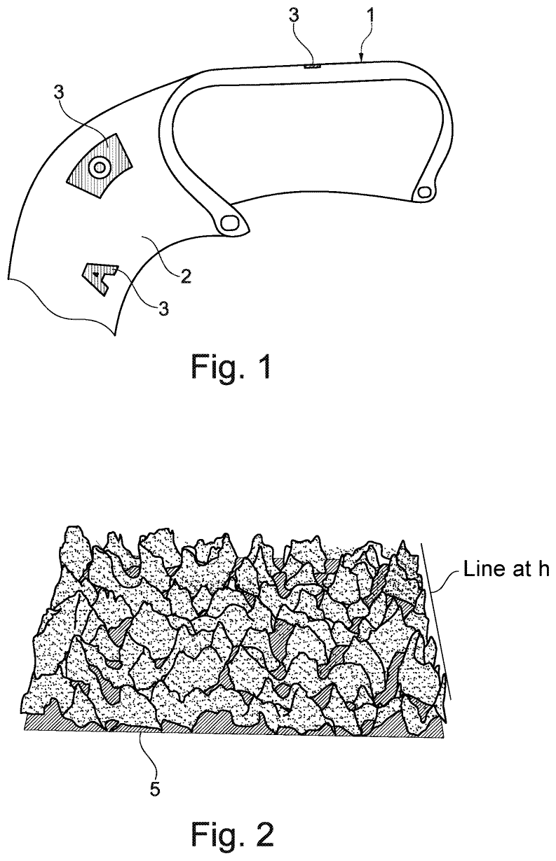

FIG. 1 shows a view of a portion of a vehicle tire with structured elements,

FIG. 2 shows a view of a detail of a microstructure,

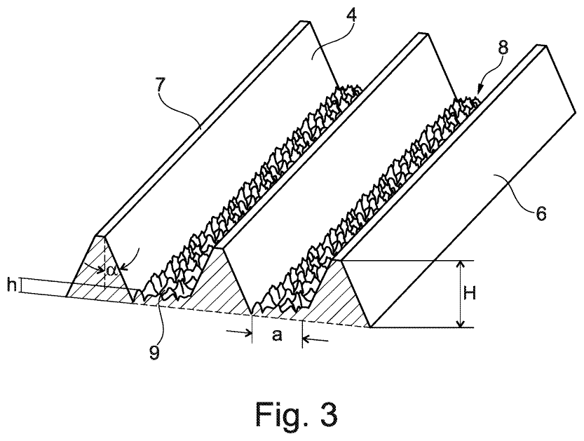

FIG. 3 shows a view of a detail of an embodiment of a structured element,

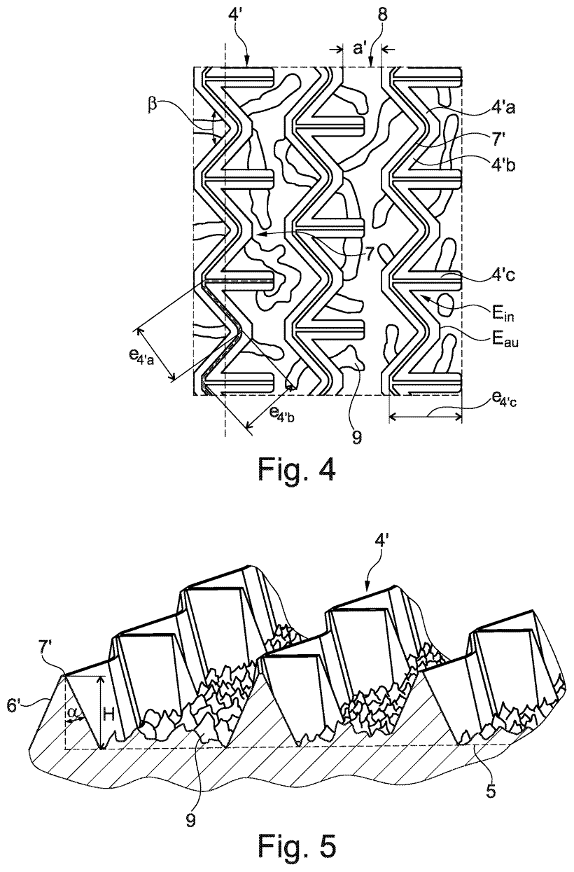

FIG. 4 shows a plan view of a detail of a further embodiment variant of a structured element,

FIG. 5 shows an oblique view of a sub-region from FIG. 4,

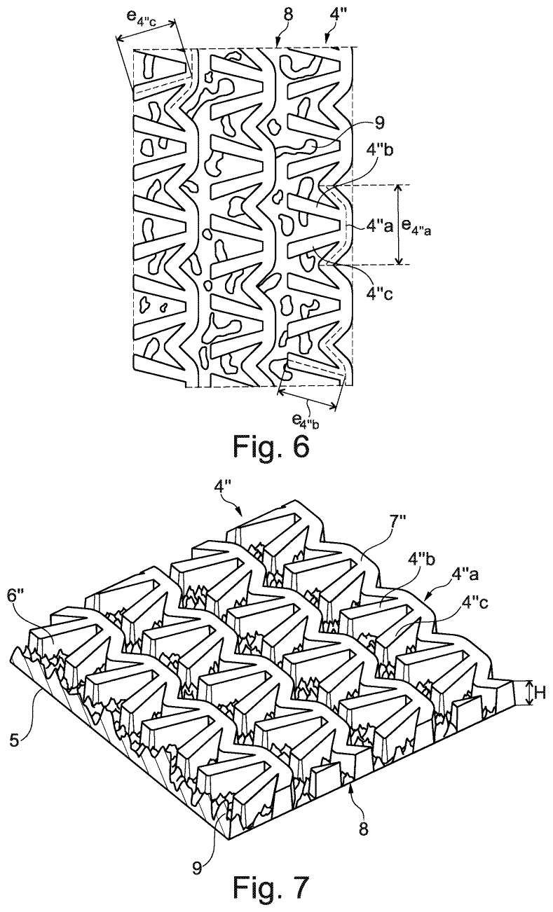

FIG. 6 shows a plan view of a detail of yet a further embodiment variant of a structured element, and

FIG. 7 shows an oblique view of the detail from FIG. 6.

FIG. 1 shows in an oblique view a circumferential portion of a vehicle tire with a tread 1, with side walls 2 and with structured areal elements 3 on the outer side of the visible side wall 2 and on the outer surface of the tread 1. Structured elements 3 may furthermore be formed for example on groove flanks and/or groove bases of grooves formed in the tread 1, and on the tire shoulders. The structured elements 3 may be embodied in any desired external configuration, for example as an image, as a logo or as a character.

The vehicle tire is preferably a pneumatic vehicle tire, in particular for passenger motor vehicles, vans, SUVs, light trucks, utility vehicles, motorcycles, buses or bicycles.

As shown in particular in FIG. 3 to FIG. 7, the structured elements 3, in combination, contain macrostructures and microstructures that are in each case structures elevated in relation to a base level 5. The base level 5 is the level of that unstructured region of the tire outer surface having the respective structured element 3, and therefore for example is the bottom of a flat depression formed in the side wall 2 and having a smooth or unstructured outer surface or is a smooth or unstructured outer surface on the tire, for example on the side wall 2 in that region where the structured element 3 or the structured elements 3 is or are formed.

The macrostructures consist of a multiplicity of ribs 4 (FIG. 3), 4′ (FIG. 4) and 4″(FIG. 6) in different arrangements and configurations that have rib portions 4′a, 4′b, 4′c, 4″a, 4″b, 4″c (FIGS. 4 and 5 and also FIGS. 6 and 7) with different profiles, and the microstructures are surface-covering, non-uniform peak-and-trough contrast structures 9 on surface elements 8 provided between the ribs 4, 4′ and 4″.

A common feature of the ribs 4, 4′ and 4″ shown in the exemplary embodiments according to FIG. 3, FIGS. 4 and 5 and FIGS. 6 and 7 is that they have a maximum height H of 0.20 mm to 0.80 mm, preferably to 0.60 mm, particularly preferably of 0.25 mm to 0.35 mm, in relation to the base level 5. The height H of the ribs 4, 4′, 4″ may also be the height averaged along the respective longitudinal extent thereof. Preferably, all the ribs 4, 4′, 4″ within a structured element 3 have a corresponding and largely constant height H. The ribs 4, 4′, 4″ preferably have a triangular or triangle-like cross section with two rib flanks 6, 6′, 6″ which fall in the direction of the base level 5 and which each extend at an acute angle a (indicated in FIG. 3 and FIG. 5) of 2° to 30°, in particular of 2° to 10°, to a perpendicular to the base level 5. The ribs 4, 4′, 4″ shown in FIGS. 3 to 7 have apex regions 7, 7′, 7″ which are in the form of a narrow plateau, preferably 0.05 mm to 0.10 mm wide, which extends continuously over all the ribs 4, 4′, 4″. The apex regions 7, 7′, 7″ may also be in the form of roundings connecting the rib flanks 6, 6′, 6″.

The described configuration of the ribs 4, 4′, 4″ includes a corresponding configuration of the rib portions 4′a, 4′b, 4′c, 4″a, 4″b and 4″c shown in the configurations of the exemplary embodiments according to FIGS. 3 and 4 and according to FIGS. 6 and 7.

The surface elements 8 provided between the ribs 4, 4′, 4″ or their rib portions 4′a, 4′b, 4′c and also 4″a, 4″b and 4″c are covered by the mentioned microstructure, which thus extends in each case as far as the lower end regions of the rib flanks 6, 6′, 6″, such that the microstructure, as mentioned, is a surface-covering, non-uniform peak-and-trough contrast structure proceeding from the base level 5, the peaks of which have a height h (FIG. 2) of 0.04 mm to 0.10 mm. In this case, the configuration is preferably such that the microstructure, interrupted by the ribs 4, 4′, 4″, extends effectively continuously over the surface of the respective structured element 3.

In a preferred configuration, the peak-and-trough contrast structure is a structure which is irregular overall, across all the surface elements 8. In an alternative configuration, the peak-and-trough contrast structure, seen over all the surface elements 8 and interrupted by the ribs 4, 4′, 4″, consists of a multiplicity of small-area contrast-structure cells which are joined together in the form of a raster and which are of corresponding shape in plan view, wherein, within each contrast-structure cell, the same non-uniformly designed peak-and-trough contrast structure is formed. The arrangement of the contrast-structure cells is in particular such that they are transferable one into the other by way of a congruence mapping, for example by way of a parallel displacement of the contrast-structure cells. For example, the contrast-structure cells have the form of rectangles, in particular squares, in plan view and have an edge length of 0.80 mm to 1.50 mm.

In a further alternative embodiment (not illustrated separately), the microstructure extends for example in a strip-shaped manner, including beyond the periphery or beyond a portion of the periphery of the structured element 3, and therefore in a region where ribs are no longer formed.

Exemplary embodiments of the arrangement and of the profile of the ribs 4, 4′, 4″ will be discussed below on the basis of FIG. 3, FIG. 4 with FIG. 5, and FIG. 6 with FIG. 7.

FIG. 3 shows an exemplary embodiment in which the ribs 4 extend alongside one another and in particular parallel or largely parallel to one another. The mutual distance a between the ribs 4 at the base level 5 is 0.20 mm to 0.80 mm. In the case of ribs 4 extending parallel or substantially parallel to one another, as illustrated, this distance therefore corresponds to the width of the microstructures extending in a strip-shaped manner between the ribs 4.

In the embodiment shown in FIGS. 4 and 5, the ribs 4′ consist in each case of rib portions 4′a, 4′b that extend with a regular zigzag form and of branching-off rib portions 4′c. The rib portions 4′a, 4′b forming the zigzag profile thus follow one another alternately and have along their central midlines extent lengths e_{4′a} and e_{4′b} which are in each case preferably of equal length among themselves and are 0.20 mm to 0.40 mm, in particular 0.25 mm to 0.30 mm. The zigzag profile of the rib portions 4′a, 4′b results in inner corner regions Eᵢₙ and outer corner regions Eₐᵤ. The rib portions 4′a, 4′b include with one another at the inner corner regions Eᵢₙ in each case an inner angle β of 70° to 120°, it preferably being the case that, for successive rib portions 4′a, 4′b, all the inner angles are equal. At all the ribs 4′, there branches off from those inner corner regions Eᵢₙ which are situated on the same sides a respective branching-off rib portion 4′c, wherein these rib portions 4′c, within a rib 4′, extend parallel or largely parallel to one another and have corresponding extent lengths e_{4′c}, which are 0.20 mm to 0.50 mm, preferably 0.25 mm to 0.40 mm.

Furthermore, the ribs 4′ extending alongside one another within a structured element 3 are offset from one another in relation to their longitudinal-extent direction in such a way that, in each case when seen transversely to the longitudinal-extent direction, a rib portion 4′a from one rib 4′ extends alongside a rib portion 4′b from the adjacent rib 4′, wherein the rib portions 4′c branching off from the inner corner regions Eᵢₙ in each case point in the direction of an inner corner region Eᵢₙ of the adjacent rib 4′. The mutual distance a′ between the mutually facing outer corner regions Eₐᵤ of adjacent ribs 4′, determined at the base level 5, is 0.20 mm to 0.40 mm. The microstructure formed in the surface elements 8 between the rib portions 4′a, 4′b, 4′c is indicated in a simplified form.

In the embodiment shown in FIG. 6 and FIG. 7, the ribs 4″ consist of a succession of rib portions 4″a, which, when seen in plan view, are in the form of correspondingly oriented isosceles trapezoids without a long base that are approximately equal in size in relation to the longitudinal-extent direction of the ribs 4″, and of rib portions 4′b, 4″c, which branch off therefrom. The rib portions 4″a each have an extent length e 4″a, determined in the extent direction of the ribs 4, of 0.40 mm to 1.00 mm, in particular of 0.50 mm to 0.80 mm. On the inner side of the rib portions 4″a, the two rib portions 4″b, 4″c branch off in pairs and so as to extend, in plan view, in a V-shaped manner with respect to one another, said two rib portions preferably having corresponding extent lengths e_{4″b} and e_{4″c} which, determined along the midlines of the rib portions 4″b, 4″c, are 0.30 mm to 0.50 mm, in particular 0.35 mm to 0.45 mm.

Furthermore, the ribs 4″ extending alongside one another within a structured element 3 are offset from one another in their longitudinal-extent direction, in particular in such a way that, when seen in plan view, for in each case two ribs 4″ extending alongside one another, in each case one set of rib portions 4″b or 4″c extend in a manner aligned with one another. In this embodiment, too, the microstructure formed in the surface elements 8 between the ribs 4″ is indicated, in FIG. 6 and FIG. 7, in a simplified form.

The production of a vehicle tire with structured areal elements 3 with a combination of a macrostructure and a microstructure, as illustrated and described, is realized in a vulcanization mold in which the mold surface or the mold surfaces, for example the inner side of side-wall shells, is provided with the corresponding negative contour(s). In one embodiment in this context of the production of such a negative structure, at the respective location of the mold surface and proceeding from the mold surface, firstly the negative of the microstructure is created, by way of laser engraving, areally over the entire area of the intended structured element 3 such that the mold surface is correspondingly depressed locally. Subsequently, depressions are created as the negative of the macrostructure, that is to say of the ribs 4, 4′, 4″, in the negative of the microstructure at the respective locations, either likewise by way of laser engraving or by way of milling. If an already finished tire blank of a vehicle tire is placed into said vulcanization mold and vulcanized, on the outer surface of the vehicle tire, at least one areal, structured element 3 with a corresponding microstructure and macrostructure is stamped into the rubber material of said vehicle tire.

### LIST OF REFERENCE SIGNS

1 . . . Tread
2 . . . Side wall
3 . . . Structured element
4, 4′, 4″ . . . Rib
4′a, 4′b, 4′c . . . Rib portion
4″a, 4″b, 4″c . . . Rib portion
5 . . . Base level
6, 6′, 6″ . . . Rib flank
7,7′,7″ . . . Apex region
8 . . . Surface element
9 . . . Peak-and-trough contrast structure
Eᵢₙ . . . Inner corner region
Eₐᵤ . . . Outer corner region
e_{4′a}, e_{4′b}, e_{4′c} . . . Extent length
e_{4″a}, e_{4″b}, e_{4″c} . . . Extent length
a, a′ . . . Distance
α, β . . . Angle
H . . . Height of the ribs 4, 4′, 4″
h . . . Height of the peaks of the peak-and-trough contrast structure
m . . . Midline

1. A vehicle tire having at least one areal, structured element which is formed on the outer surface of said vehicle tire and contains a combination of macrostructures and microstructures, which are in each case structures which are elevated in relation to a base level, wherein the macrostructure consists of a multiplicity of ribs with apex regions which have a height of 0.20 mm to 0.80 mm in relation to the base level, wherein the microstructure covers surface elements provided between the ribs and is or comprises a non-uniform peak-and-trough contrast structure whose peaks have different heights, with a maximum height in relation to the base level that is smaller than the height of the ribs,
wherein the peaks of the peak-and-trough contrast structure have a height of 0.04 mm to 0.10 mm.

2. The vehicle tire as claimed in claim 1, wherein the peak-and-trough contrast structure extends so as to be interrupted by the ribs but otherwise continuously over the surface or at least a part of the surface of the structured element.

3. The vehicle tire as claimed in claim 1, wherein the peak-and-trough contrast structure is made up of a multiplicity of small-area contrast-structure cells which are joined together in the form of a raster and which are of corresponding shape in plan view, wherein, within each contrast-structure cell, the same non-uniformly designed peak-and-trough contrast structure is formed.

4. The vehicle tire as claimed in claim 3, wherein the contrast-structure cells are arranged in such a way as to be transferable one into the other by way of a congruence mapping.

5. The vehicle tire as claimed in claim 3, wherein the contrast-structure cells have the form of rectangles, in particular squares, in plan view and have edge lengths of 0.80 mm to 1.50 mm.

6. The vehicle tire as claimed in claim 1, wherein the ribs of the macrostructure have a height of up to 0.60 mm, preferably of 0.25 mm to 0.35 mm.

7. The vehicle tire as claimed in claim 1, wherein, within a structured element, the ribs of the macrostructure have heights that are equal and that remain constant over the extent of the ribs.

8. The vehicle tire as claimed in claim 1, wherein the ribs extend alongside one another, in particular parallel to one another, in the manner of hatching, wherein the surface elements covered by a microstructure have a width of 0.20 mm to 0.80 mm between mutually adjacent ribs.

9. The vehicle tire as claimed in claim 1, wherein the ribs have successive rib portions which differ from one another in terms of their profile relative to the extent direction of the ribs or which, in plan view, have a specific configuration, for example in the form of correspondingly oriented isosceles trapezoids without a long base that are approximately equal in size.

10. The vehicle tire as claimed in claim 1, wherein the ribs have further rib portions which branch off from rib portions.

11. The vehicle tire as claimed in claim 1, wherein the clear distance between the rib portions of mutually adjacently extending ribs is at least 0.20 mm and in particular up to 0.80 mm.

12. A method for producing a vehicle tire designed as claimed in claim 1,
comprising the following steps:
creating a negative contour of at least one structured element in a mold surface of a vulcanization mold for shape-imparting vulcanization of the vehicle tire,
wherein firstly the negative of the microstructure is created, by way of laser engraving of the mold surface, so as to extend over the entire area of the structured element to be formed,
and subsequently the negative structure of the macrostructure is created as depressions on the negative of the microstructure by way of laser engraving or by way of milling,
wherein, by means of the vulcanization mold, shape-imparting vulcanization of the tire blank of the vehicle tire is performed, whereby the structured element is stamped via the negative structure, and thus with a macrostructure composed of ribs and with the microstructure between the ribs, on the outer surface of the vehicle tire.

13. A vulcanization mold for shape-imparting vulcanization of a vehicle tire designed as claimed in claim 1,
wherein the vulcanization mold has at least one mold surface in which the negative structure of a structured element made up of the macrostructure composed of ribs and the microstructure composed of a non-uniform peak-and-trough contrast structure is contained,
wherein the negative structure has depressions for forming the ribs and the negative structure of the microstructure on surface elements between the ribs.

14. The vehicle tire as claimed in claim 1, wherein the ribs have a maximum height of 0.20 mm to 0.80 mm in relation to the base level, in which all the ribs within the structured element have a corresponding and constant height, and the ribs have a triangular cross section with two rib flanks which fall in the direction of the base level and which each extend at an acute angle of 2° to 30° to a perpendicular to the base level, with the ribs having apex regions which are rounded or in the form of a narrow plateau of 0.05 mm to 0.10 mm wide, in which the apex regions extend continuously over all the ribs.

15. The vehicle tire as claimed in claim 14, wherein the peak-and-trough contrast structure consists of a multiplicity of small-area contrast-structure cells which are joined together in the form of a raster and which are of corresponding shape in plan view, wherein, within each contrast-structure cell, the same non-uniformly designed peak-and-trough contrast structure is formed, and the arrangement of the contrast-structure cells is such that they are transferable one into the other by way of a congruence mapping.
